(19) United States
(12) Patent Application Publication
(10) Pub. No.: US 2022/0322862 A1
(43) Pub. Date: Oct. 13, 2022

(54) Decorative Tree

(71) Applicant: Alpine Corporation, City of Industry, CA (US)

(72) Inventors: Sohrab Robby Soofer, Beverly Hills, CA (US); Jodie Winters, Woodland Hills, CA (US)

(21) Appl. No.: 17/717,002

(22) Filed: Apr. 8, 2022

Related U.S. Application Data
(60) Provisional application No. 63/173,290, filed on Apr. 9, 2021.

(51) Int. Cl. A47G 33/06; F21V 33/00; H04R 1/02

(52) U.S. Cl. CPC A47G 33/06; F21V 33/0028; H04R 1/028

(57) ABSTRACT

Provided is a decorative artificial tree comprising: a) a trunk; b) a plurality of branches attached to the trunk; c) a plurality light sources placed at the end of one or more of the branches; and d) a speaker; wherein the light sources illuminate and the speaker plays audio. The branches can be configured to be moved to a different position by a user. The tree can have a stowed configuration that can be changed to another configuration by a user. The branches can have two or more sub-branches, with the light placed at the end of the sub-branches. The trunk's shape is not configured to be changed. The branches can be made from a bendable wire. The tree trunk and/or branches can have a wrapping, such as aluminum foil. The tree trunk and/or branches can have a coating, such as a with a white colored polymer. The tree can have a detachable base.

### CROSS-REFERENCE

The present application claims the benefit of U.S. Provisional patent application No. 63/173,290, filed on Apr. 9, 2021, which is incorporated herein by reference in its entirety.

### BACKGROUND SECTION OF THE INVENTION

Christmas trees are used for decorative purposes. A problem with the use of real trees, such as Christmas trees, is that they are bulky and difficult to ship. The use of real trees also has an environmental cost and provides few options to a user to manipulate how the tree looks. There is a need in the art for an artificial decorative tree that can be shipped easily and allows a user the option to manipulate the looks of the tree.

### SUMMARY SECTION OF THE INVENTION

Provided is a decorative tree comprising: a) a tree having a trunk and branches; b) a plurality of branches with lights at the end of one or more of the branches; c) a base; d) and a speaker. Provided is a decorative tree comprising: a) a tree having a trunk and bendable branches b) a plurality of branches with lights at the end of one or more of the branch c) a base, and d) a speaker. Part or all of the tree, such as the branches, can be made from wires, and/or bendable and/or reshapeable wires for the branches. The tree branches can be covered, such as with aluminum foil or a white colored polymer. The speaker can be placed on the base and/or trunk and/or branch of a tree.

Provided is a decorative artificial tree comprising: a) a trunk; b) a plurality of branches attached to the trunk; c) a plurality light sources placed at the end of one or more of the branches; and d) a speaker; wherein the light sources illuminate and the speaker plays audio. The branches can be configured to be moved to a different position by a user. The tree can have a stowed configuration that can be changed to another configuration by a user. The branches can have two or more sub-branches, with the light placed at the end of the sub-branches. The trunk's shape is not configured to be changed. The branches can be made from a bendable wire. The tree trunk and/or branches can have a wrapping, such as aluminum foil. The tree trunk and/or branches can have a coating, such as a with a white colored polymer. The tree can have a detachable base.

Provided is a decorative artificial tree comprising: a) a trunk; b) a plurality of branches made from bendable wire attached to the trunk; c) a plurality of sub-branches made from bendable wire attached to one of the plurality of the branches; d) a plurality light sources placed on the sub-branches; e) a speaker; wherein the light sources illuminate, and the speaker plays audio.

Provided is a decorative artificial tree comprising: a) a trunk; b) a plurality of branches attached to the trunk; c) a plurality of light sources on the one or more of the branches; d) a speaker; wherein the light sources illuminate and the speaker plays audio.

### BRIEF DESCRIPTION OF THE INVENTION

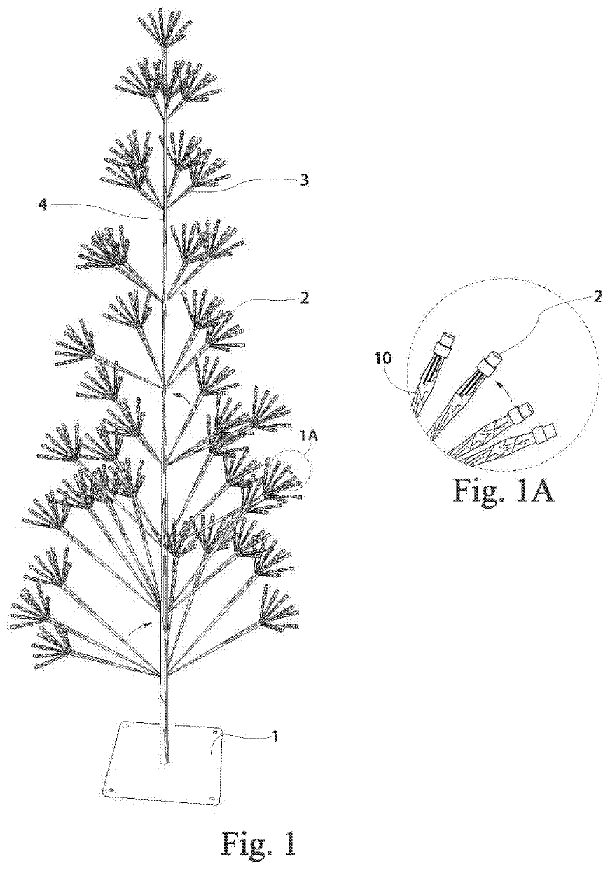

FIG. 1 illustrates a decorative tree on a base with branches extending out from the trunk.

FIG. 1A illustrates a closeup of a branch of the tree of FIG. 1.

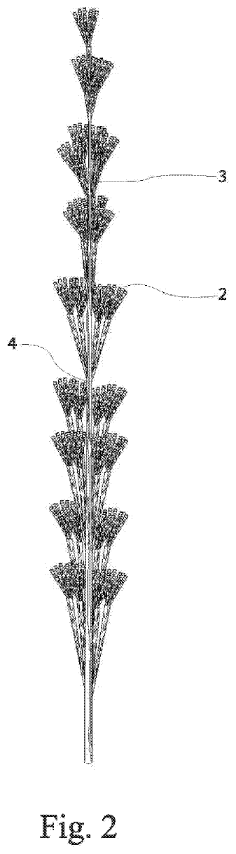

FIG. 2 illustrates the decorative tree on a base with branches bent towards the trunk (stowed position).

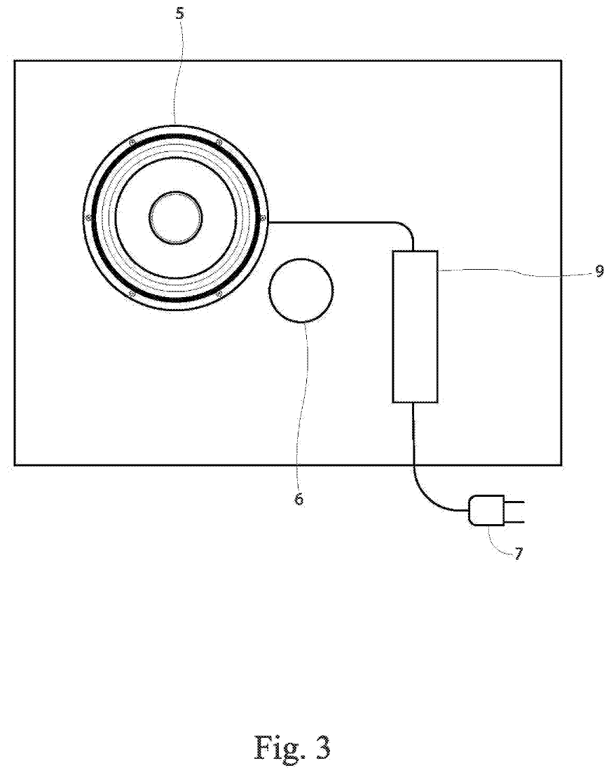

FIG. 3 illustrates a top view of the base of FIG. 1.

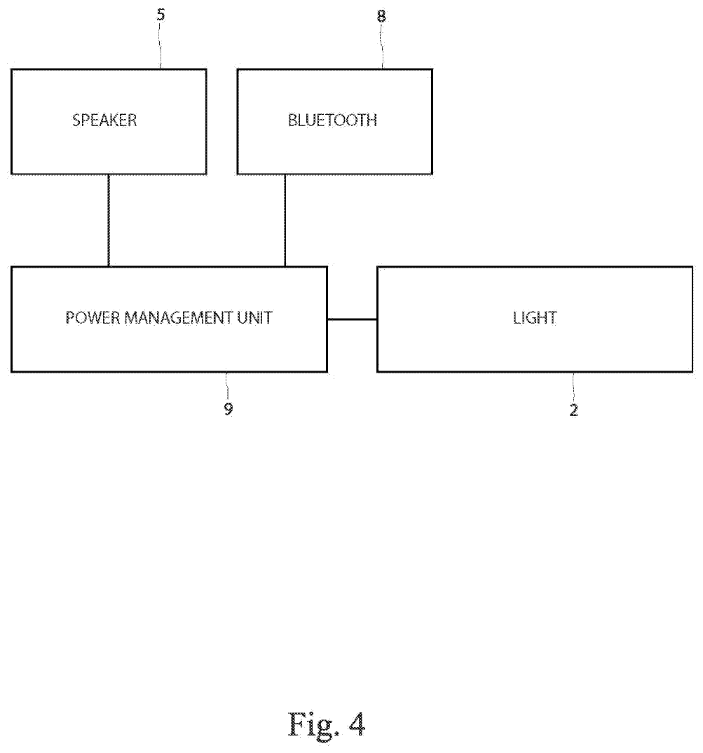

FIG. 4 illustrates electric components of the decorative tree.

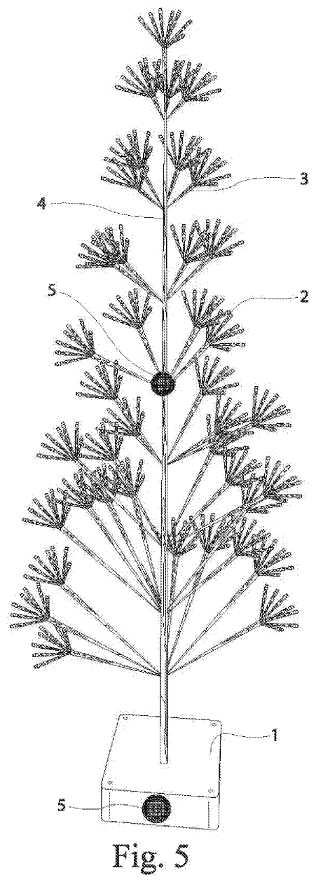

FIG. 5 illustrates placement of the speaker on a rectangular base and/or on the trunk/branch of the tree.

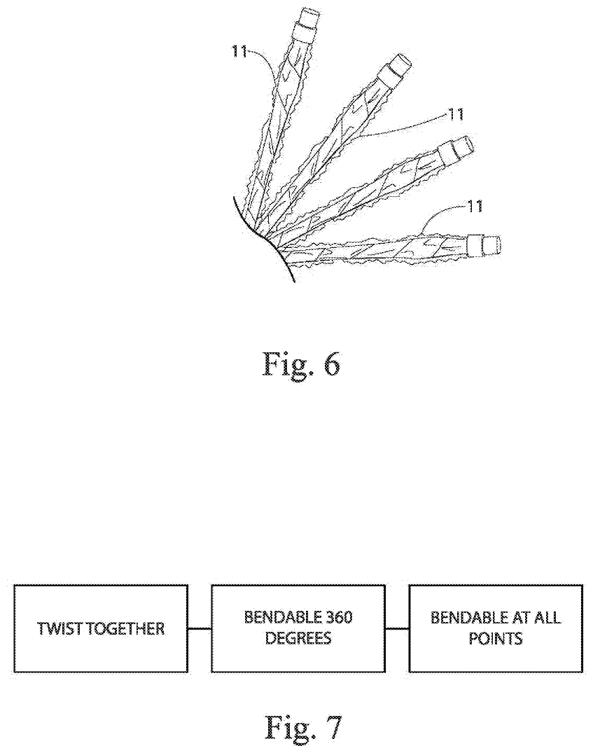

FIG. 6 illustrates a polymer coating on the sub-branches, simulating snow on the tree.

FIG. 7 illustrates the different actions that can be carried out on a branch, such as twisting and bending.

### DETAILED DESCRIPTION OF THE DRAWINGS

Provided is a decorative non-living tree. The tree can have foldable branches that allow a user to both store the tree in a substantially flat container, such as a box, to allow for shipping of the tree in a box with minimal thickness, for example less than 12 inches or 6 inches to 12 inches. The branches (including any sub-branches) can extend from the trunk of the tree. Some or all the branches can have lights at the end of each branch. The branches can be bent. The lights can be powered by plugging in a power source to an outlet or with a rechargeable battery. The decorative tree can have a base with a wired or wireless speaker. A user can connect to the speaker in a wireless fashion.

FIG. 1 illustrates a decorative tree on a base 1 with branches 3 extending out from the trunk 4. The base 1 can have a flat bottom for placement of the base on a surface. The base 1 can have the shape of a rectangle or square. The base 1 can have one or more openings for fastening the base to a surface. The base can have an opening for securing the tree to a ground with a stake.

The branches 3 can have lights 2 at the ends of each branch. The lights can be LED (light emitting diodes). The LEDs can emit different colors. The color of each LED light can change, and each LED can exhibit multiple colors. The colors can change synchronously with the sound coming from the speaker.

The branches 3 can be made from a bendable and/or flexible metal that can be reshaped. Examples of metals include aluminum, copper, and zinc. In one embodiment, aluminum is used. The branches, including the branch ends, can be bent to contact each other. The metal branches can be twisted, and reshaped, and, can be wrapped around each other. The metal skeleton of the branches 3 can be covered, such as with aluminum foil in one embodiment. In another embodiment, the branches can be covered with a polymer 11, such as white polymer that resembles fake snow.

The branches 3 can bend inward or outward from the trunk 4. The trunk 4 can be made of metal. The trunk can retain its shape when bending the branches. The trunk can be fastened to the base.

FIG. 2 illustrates the decorative tree on a base 1 with branches 3 bent towards the trunk 4. This is a flat configuration of the tree for shipping. A user manipulates the branches 3 to obtain a tree with a desirable configuration.

FIG. 3 illustrates a top view of the base 1 of FIG. 1 in an embodiment where the speaker 5 faces upwardly. A speaker 5 can be placed on the base 1. The speaker 5 can be fastened to the base. The speaker 5 can have a circular shape. The speaker 5 can be placed within and/or on the trunk 4. The base has an opening 6 for attachment of the trunk 4. The bottom of a base can also be configured to receive a stake for attaching to a ground.

In one embodiment, a plurality of trees play the same sound from a different speaker in a synchronous manner. This simple network with electronic device of a user and one speaker. There can also be a mesh network where each speaker is configured to communicate with the smart phone and every other speaker. The user's phone can be configured to communicate with each speaker. In another embodiment, one speaker can act as a master, and then communicating with all the other speakers, in this housing sending audio content to the other speakers.

The base can have a power management unit 9. The power management unit 9 can be connected to an outlet by a plug 7. Alternatively, the tree can be powered by a rechargeable battery.

FIG. 4 illustrates exemplary communication between the different electronic elements. The speaker 5 can be in communication with a (PMU) Power Management Unit 9. The PMU 9 can control and monitor the electrical current and/or voltage of the speaker system 5 and the lights 2. The PMU 9 can also be in communication with Bluetooth 8 configured for wireless communication.

FIG. 5 illustrates placement of the speaker on the base and/or on the tree truck and/or branches. In this embodiment, the base has a sufficient height to accommodate a speaker inside and on the side. Alternatively, the speaker can be attached to the branch/trunk with a loop holder and/or a fastener.

### REFERENCES

1. Base
2. Light
3. Branch
4. Trunk
5. Speaker
6. Opening in base
7. Plug
8. Bluetooth
9. Power Management Unit
10. Wrapping
11. Polymer

What is claimed is:

1. A decorative artificial tree comprising:
a) a trunk;
b) a plurality of branches attached to the trunk;
c) a plurality light sources placed at the end of one or more of the branches; and
d) a speaker;
wherein the light sources illuminate and the speaker plays audio.

2. The decorative artificial tree of claim 1, wherein the branches are configured to be moved to, a different position by a user.

3. The decorative artificial tree of claim 2, wherein the tree has a stowed configuration that can be changed to another configuration by a user.

4. The decorative artificial tree of claim 1, wherein at least one of the branches has two or more sub-branches, with the light placed at the end of the sub-branches.

5. The decorative artificial tree of claim 2, wherein the trunk's shape is not configured to be changed.

6. The decorative artificial tree of claim 1, wherein the branches are made from a bendable wire.

7. The decorative artificial tree of claim 1, further comprising a wrapping around at least a portion of the tree.

8. The decorative artificial tree of claim 7, wherein the wrapping is aluminum foil.

9. The decorative artificial tree of claim 1, further comprising coating at, least a portion of the tree with a polymer.

10. The decorative artificial tree of claim 9, wherein the polymer is white colored.

11. The decorative artificial tree of claim 1, further comprising a detachable base for attaching the trunk.

12. The decorative artificial tree of claim 11, wherein the speaker is on the base.

13. The decorative artificial tree of claim 1, wherein the speaker is attached to one or more of the branches or the trunk.

14. A decorative artificial tree comprising:
a) a trunk;
b) a plurality of branches made from bendable wire attached to the trunk;
c) a plurality of sub-branches made from bendable wire attached to one of the plurality of the branches;
d) a plurality light sources placed on the sub-branches;
e) a speaker;
wherein the light sources illuminate, and the speaker plays audio.

15. The decorative artificial tree of claim 14, further comprising a wrapping around at least a portion of the tree.

16. The decorative artificial tree of claim 14, wherein the sub-branches can be twisted around each other.

17. A decorative artificial tree comprising:
a) a trunk;
b) a plurality of branches attached to the trunk;
c) a plurality of light sources on the one or more of the branches;
d) a speaker;
wherein the light sources illuminate and the speaker plays audio.

18. The decorative artificial tree of claim 17, further comprising a wrapping on some of the branches.
